(19) United States
(12) Patent Application Publication
(10) Pub. No.: US 2009/0116333 A1
(43) Pub. Date: May 7, 2009

(54) Magnetic stirrer

(76) Inventors: Hsin-Hung LU, Dongshan Township (TW); Chang-Cheng TSAI, Jhonghe City (TW)

Correspondence Address: SINORICA, LLC, 528 FALLSGROVE DRIVE, ROCKVILLE, MD, 20850, US

(21) Appl. No.: 11/965,545

(22) Filed: Dec. 27, 2007

(30) Foreign Application Priority Data
Nov. 2, 2007 (TW) 096141437

(51) Int. Cl. B01F 15/06

(52) U.S. Cl. 366/145; 366/144

(57) ABSTRACT

A magnetic stirrer is disclosed. The magnetic stirrer is disposed with a gas entrance pipeline system and a liquid entrance pipeline system. The pipes of the gas entrance pipeline system and the liquid entrance pipeline system are connected with one another by one-touch fitting. A plurality of adjustment valves is arranged on the pipeline systems for adjusting gas flow and liquid flow. The magnetic stirrer is arranged with a heating plate so that the magnetic stirrer can perform heating and stirring processes at the same time. When not being used, the heating plate is disassembled. Therefore, the magnetic stirrer reduces time for constructing experiment equipments, increases convenience of use and further improves the efficiency of experiments.

### BACKGROUND OF THE INVENTION

The present invention relates to a stirrer, especially to a magnetic stirrer.

Magnetic stirrers are broadly used in organic synthesis, environmental analysis and biochemistry science as basic tools. The main function of the stirrer is to stir a plurality of chemical reactants so as to make them mix evenly, increase effective collisions of chemical molecules and further enhance chemical reactions. There are a lot of equipment required for perform experiments. It takes quite a lots time to connect pipelines. Generally, reaction containers are made from glass and plastic soft lines are difficult to connect with connectors of the reaction container. On the other hand, it's also quite troublesome to separate the plastic soft lines with the connectors of the reaction container.

Stirring hot plate available now on the market includes a hot plate fixed on the device. Although stirring and heating being performed simultaneously, the hot plate is unable to be disassembled for being used independently.

Moreover, addition of the hot plate increases the size of the device and addition of a control panel of the hot plate complicates internal structure of the device. All cause users some trouble.

In order to solve above problem, the present invention provides a magnetic stirrer that is built in with a gas pipeline system and a liquid pipeline system so as to reduce time for constructing experimental equipment and increase convenience of use.

### SUMMARY OF THE INVENTION

Therefore it is a primary object of the present invention to provide a magnetic stirrer with a gas pipeline system and a liquid pipeline system. The pipes of the gas pipeline system and the liquid pipeline system are connected with one another by one-touch fitting so as to reduce time for constructing experiment equipments and increase convenience of use. Thus the efficiency of experiments is further improved.

It is another object of the present invention to provide a magnetic stirrer disposed with a detachable heating plate so as to perform heating and stirring processes at the same time. The heating plate can be disassembled and used separately.

In order to achieve above objects, a magnetic stirrer of the present invention consists of a main body, a gas entrance, a liquid entrance, two adjustment valves, a gas output, a first liquid output, a second liquid output and a liquid exit and a heating plate. The gas entrance, the liquid entrance, the two adjustment valves, the gas output, the first liquid output, the second liquid output and the liquid exit are disposed on the main body. The gas entrance is connected to the gas output by a transfer line. The liquid entrance is connected to the first liquid output by a transfer line. The second liquid output is connected to the liquid exit by a transfer line. The heating plate with a fastening member is arranged on the main body. The heating plate is fixed on the main body by the fastening member.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1A is a perspective view of an embodiment according to the present invention;

FIG. 1B is an explosive view of an embodiment according to the present invention;

FIG. 2 is a perspective view of another embodiment according to the present invention;

FIG. 3 is a schematic drawing showing assembly of a heating plate and a magnetic stirrer.

### DETAILED DESCRIPTION OF THE PREFERRED EMBODIMENT

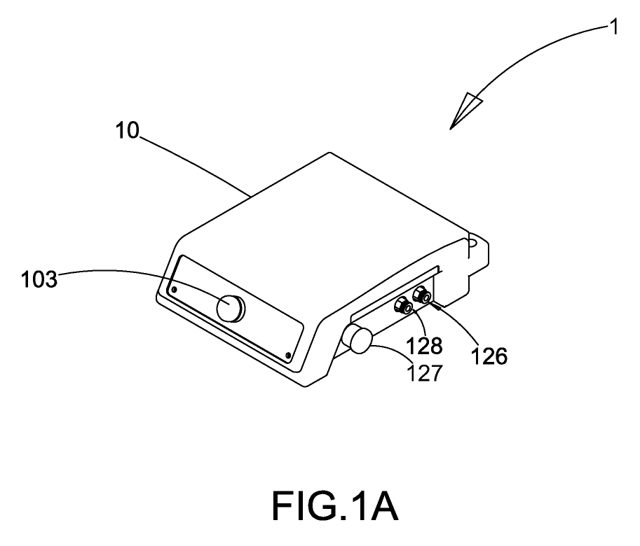

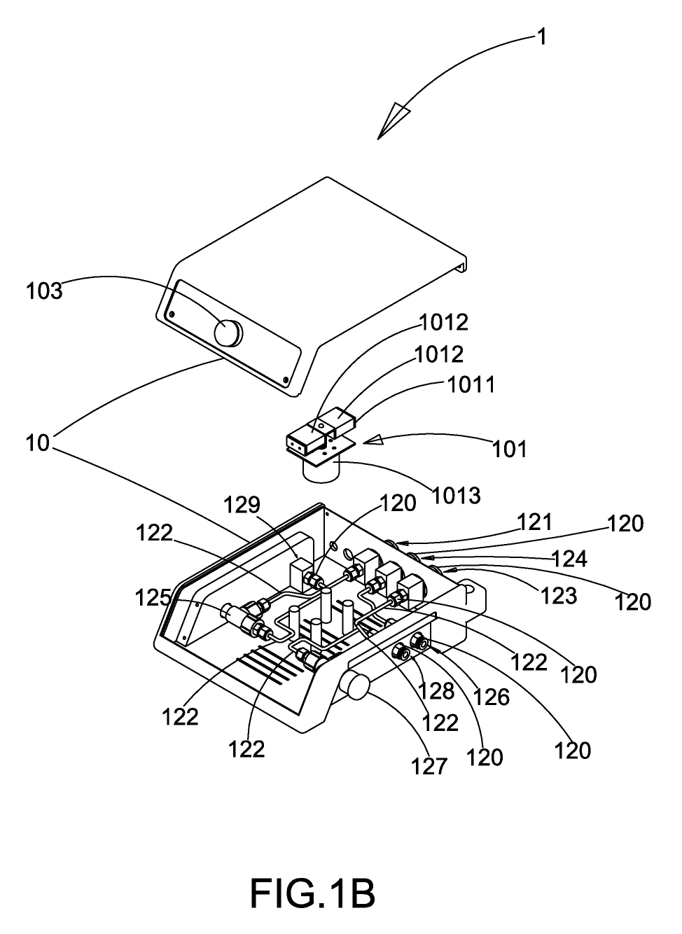

Refer to FIG. 1A & FIG. 1B, a magnetic stirrer 1 consists of a main body 10 and a control member 103. The main body 10 includes a magnetic member 101 with a magnetic base 1011 and a motor 1013. The motor 1013 drives the magnetic base 1011 to rotate. A magnet 1012 is arranged on each end of the magnetic base 1011. The two magnets 1012 have different magnetic properties. When the magnetic stirrer 1 is used to stir chemical reactants in a container, a magnetic bar is put into the container. Thus when the magnetic base 1011 rotates, the magnetic bar inside the container also stirs so as to mix the reactants. The control member 103 is connected with the magnetic member 101 so as to control rotation speed of the motor 1013 of the magnetic member 101 and further control stirring speed of the magnetic stirrer 1.

The magnetic stirrer 1 of the present invention features on that the magnetic stirrer 1 is disposed with a gas pipeline system and a liquid pipeline system. Thus the main body 10 is arranged with a gas entrance 121, a liquid entrance 123, two adjustment valves 125, 127, a gas output 129, a first liquid output 128, a second liquid output 126 and a liquid exit 124. The gas entrance 121 is connected to the gas output 129 by a transfer line 122 while the adjustment valve 125 is arranged between the gas entrance 121 and the gas output 129. The other adjustment valve 127 is disposed between the liquid entrance 123 and the first liquid output 128. The second liquid output 126 is connected to the liquid exit 124 by the transfer line 122. The above gas entrance 121, the liquid entrance 123, the gas output 129, the first liquid output 128, the second liquid output 126 and the liquid exit 124 respectively have a connector 120 so as to make connection type of each transfer line 122 become one-touch fitting type.

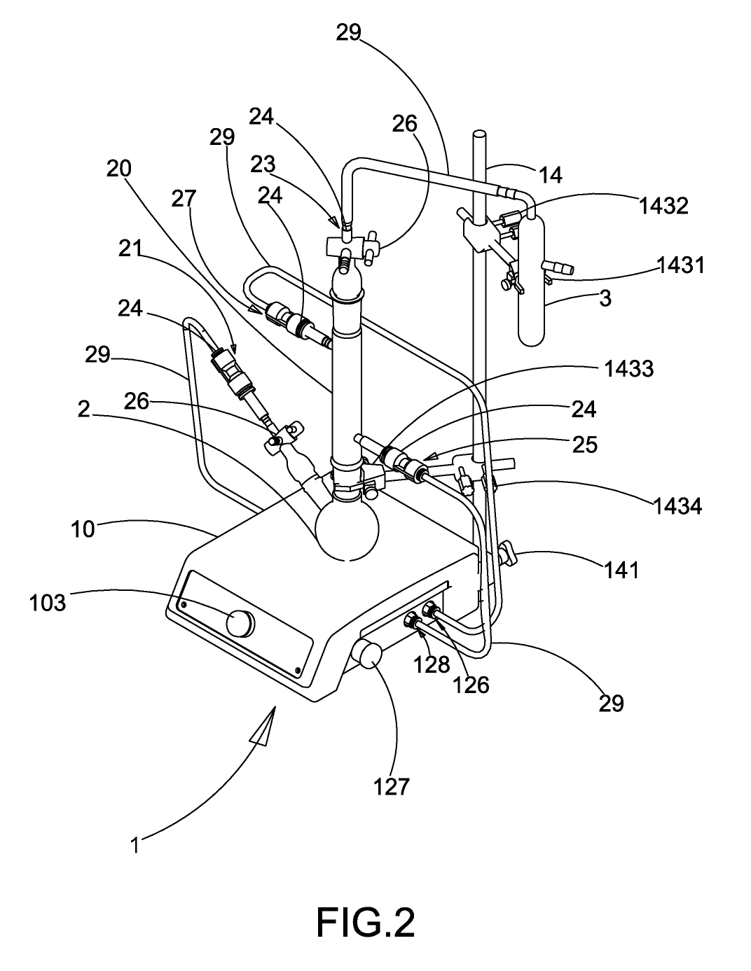

Refer to FIG. 2, another embodiment of the present invention is revealed. The difference between this embodiment and the embodiment in FIG. 1A is in that the magnetic stirrer 1 further includes a reaction container 2 and a condenser 20. The reaction container 2 is arranged over the main body 10. The condenser 20 is arranged over the reaction container 2. The reaction container 2 is composed of a gas inlet 21. The gas inlet 21 is connected with the gas output 129 of the magnetic stirrer 1 by a transfer line 29. The condenser 20 is composed of a gas outlet 23, a liquid inlet 25 and a liquid outlet 27. The gas outlet 23 is connected with a blow down vessel 3 by a transfer line 29. The blow down vessel 3 is filled with a liquid and which kind of liquid being filled depends on the gas exhausted from the gas outlet 23. For example, once gas exhausted from the gas outlet 23 is inert gas, the liquid in the blow down vessel 3 is oil because oil isolates the gas with water and oxygen. An adjustment valve 26 is arranged on the gas inlet 21 as well as the gas outlet 23 for control of gas flow. The liquid inlet 25 is connected with the first liquid output 128 of the magnetic stirrer 1 by a transfer line 29 while the liquid outlet 27 connects with the second liquid output 126 of the magnetic stirrer 1. The gas inlet 21, the gas outlet 23, the liquid inlet 25 and the liquid outlet 27 respectively have a connector 24 so as to make each transfer line 29 connect with one another in one-touch fitting.

In order to fix the reaction container 2 and the blow down vessel 3, the magnetic stirrer 1 further includes a support post 14, as shown in FIG. 2. The support post 14 is fixed on the main body 10 by a fastening part 141. The support post 14 further consists of a plurality of clip members 143. In this embodiment, the support post 14 is disposed with a first clip member 1431 and a second clip member 1433 while the first clip member 1431 clips the blow down vessel 3 and the second clip member 1433 clips the reaction container 2. The first clip member 1431 and the second clip member 1433 respectively are arranged with an adjustment member 1432, 1434. The adjustment members 1432, 1434 enable the first clip member 1431 with the blow down vessel 3 and the second clip member 1433 with the reaction container 2 to move along the support post 14. Once the first clip member 1431 or the second clip member 1433 moves to a proper position, the first clip member 1431 or the second clip member 1433 is fastened and fixed on the support post 14 by the adjustment members 1432, 1434.

When a gas steel bottle is connected with the gas entrance 121 of the magnetic stirrer 1, the gas flow to the adjustment valve 125 of the gas entrance 121 and then adjust the adjustment valve 125 so as to control gas flow and make the gas flow into the gas output 129. The gas output 129 connects with the gas inlet 21 of the reaction container 2 and the condenser 20 so that the gas is blew into the reaction container 2. The gas inlet 21 of the reaction container 2 and the gas outlet 23 of the condenser 20 respectively have corresponding adjustment valve 26 so as to control the gas flow. When there is too much gas inside the reaction container 2 and the pressure therein is too high, the gas is exhausted to the blow down vessel 3 through the gas outlet 23 so as to reduce pressure inside the reaction container 2.

When a container with condensed liquid is connected with the liquid inlet 123, the liquid flow to the adjustment valve 127 of the liquid inlet 123 and then adjust the adjustment valve 127 so as to control the liquid flow. The first liquid output 128 connects with the adjustment valve 127 and the liquid inlet 25 of the condenser 20 so that the condensed liquid flows into the condenser 20 to reduce vapor temperature in the reaction container 2. The condensed liquid is discharged through the liquid outlet 27 of the condenser 20, the second liquid output 126 of the magnetic stirrer 1, into the liquid exit 124.

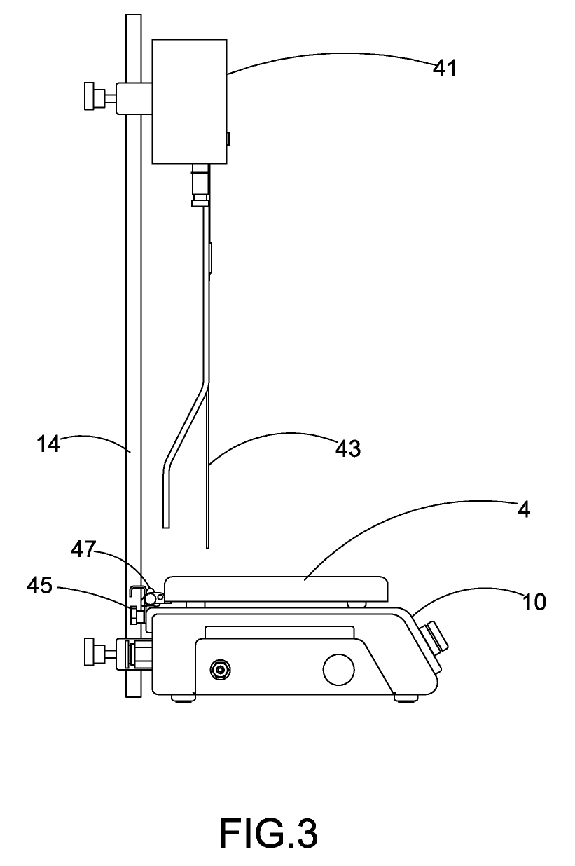

Refer to FIG. 3, the magnetic stirrer 1 of the present invention further includes a heating plate 4 disposed on the main body 10. For temperature control, a temperature control member 41 is connected to the heating plate 4 for control of temperature of the heating plate 4. The temperature control member 41 is PID (proportional-integral-derivatice) control member. An electronic thermometer 43 is disposed on the temperature control member 41 for measuring temperature of the reaction container 2. In order to fix the heating plate 4 on the main body 10, a fastening part 45 is arranged on one side of the heating plate 4. An adjustment member 47 is disposed between the heating plate 4 and the fastening part 45 so as to adjust and make the fastening part 45 on the same plane with the heating plate 4. Thus the heating plate 4 can be used separately.

In summary, a magnetic stirrer of the present invention is disposed with a gas entrance pipeline system and a liquid entrance pipeline system. The pipes of the gas entrance pipeline system and the liquid entrance pipeline system are connected with one another by one-touch fitting so as to reduce time for constructing experiment equipments. Moreover, a plurality of adjustment valves is arranged on the pipeline systems for adjusting gas flow and liquid flow. Furthermore, the magnetic stirrer is arranged with a heating plate so that the magnetic stirrer can perform heating and stirring processes at the same time. When not being used, the heating plate is removed. Therefore, the convenience of use is effectively improved and the efficiency of experiments is further raised.

Additional advantages and modifications will readily occur to those skilled in the art. Therefore, the invention in its broader aspects is not limited to the specific details, and representative devices shown and described herein. Accordingly, various modifications may be made without departing from the spirit or scope of the general inventive concept as defined by the appended claims and their equivalents.

What is claimed is:

1. A magnetic stirrer comprising:
a main body;
a gas entrance disposed on the main body;
a liquid entrance arranged on the main body;
a gas output disposed on the main body and connected to the gas entrance by a transfer line;
a first liquid output disposed on the main body and connected to the liquid entrance by a transfer line;
a second liquid output disposed on the main body;
a liquid exit disposed on the main body and connected to the second liquid output by a transfer line; and
a heating plate having a fastening member and disposed on the main body; the fastening member fixes the heating plate on the main body.

2. The device as claimed in claim 1, wherein the magnetic stirrer further comprising
a temperature control member having an electronic thermometer, being connected to the heating plate.

3. The device as claimed in claim 2, wherein the temperature control member is PID (proportional-integral-derivatice) control member.

4. The device as claimed in claim 1, wherein an adjustment member is disposed between the heating plate and the fastening part.

5. The device as claimed in claim 1, wherein the magnetic stirrer further comprising a reaction container disposed on the main body and the reaction container having:
a gas inlet connected to the gas output of the magnetic stirrer by a transfer line.

6. The device as claimed in claim 5, wherein the reaction container further comprising a condenser and the condenser having:
a liquid inlet connected with the first liquid output of the magnetic stirrer by a transfer line;
a liquid outlet connected with the second liquid output of the magnetic stirrer by a transfer line; and
a gas outlet.

7. The device as claimed in claim 6, wherein a connector is disposed on the gas inlet of the reaction container as well as the gas outlet, the liquid inlet and the liquid outlet of the condenser.

8. The device as claimed in claim 6, wherein the magnetic stirrer further comprising two adjustment valves respectively disposed on the gas inlet of the reaction container and the gas outlet of the condenser.

9. The device as claimed in claim 6, wherein the gas outlet gas outlet is connected with a blow down vessel by a transfer line.

10. The device as claimed in claim 9, wherein the blow down vessel is filled with a liquid and which kind of liquid being filled depends on the gas exhausted from the gas outlet.

11. The device as claimed in claim 5, wherein the magnetic stirrer further comprising a support post for connecting the blow down vessel with the reaction container.

12. The device as claimed in claim 11, wherein the magnetic stirrer is disposed with a fastening part that fixes the support post on the main body.

13. The device as claimed in claim 12, wherein the support post is disposed with a plurality of clip members that respectively clip the blow down vessel or the reaction container and being fixed on the support post.

14. The device as claimed in claim 13, wherein the clip members respectively are arranged with an adjustment member so as to move the clip member along the support post.

15. The device as claimed in claim 1, wherein the magnetic stirrer further comprising two adjustment valves respectively disposed between the gas entrance and the gas output as well as between the liquid entrance and the first liquid output.

16. The device as claimed in claim 1, wherein a connector is disposed on the gas entrance, the liquid entrance, the gas output, the first liquid output, the second liquid output and the liquid exit respectively.

17. The device as claimed in claim 1, wherein the main body comprising:
a magnetic member having a magnetic base and two magnets, the magnets arranged on each end of the magnetic base respectively; and
a motor driving the magnetic base to rotate.
